(19) United States
(12) Patent Application Publication
(10) Pub. No.: US 2009/0127882 A1
(43) Pub. Date: May 21, 2009

(54) Trapping device for vehicle use

(76) Inventor: Carole Thibodeau, Quebec (CA)

Correspondence Address: Mrs. Carole Thibodeau, 1385 Pierre-Baudin, Quebec, QC, G2K 2H9, CA

(21) Appl. No.: 11/985,553

(22) Filed: Nov. 16, 2007

(51) Int. Cl. B60N 3/00

(52) U.S. Cl. 296/37.8; 296/1.07

(57) ABSTRACT

A trapping device for vehicle use, which is installed between a floor-mounted console and a vehicle seat to trap objects that might fall between or under the vehicle seats.

### BACKGROUND OF THE INVENTION

1. Field of the Invention

This invention concerns a trapping device for vehicle use, which is installed between a floor-mounted console and a vehicle seat to trap objects that might fall between or under the vehicle seats.

2. Description of the Related Art

A search of prior art records has unveiled the following patents:
1. U.S. Pat. No. 4,568,117 issued in 1986 to McElfish;
2. U.S. Pat. No. 5,169,097 issued in 1992 to Yasukawa;
3. U.S. Pat. No. 5,169,105 issued in 1992 to Yasukawa; and
4. U.S. Pat. No. D 494,717 issued in 2004 to Slone.

### SUMMARY OF THE INVENTION

A feature of the present invention is therefore to provide a device with a fastening means to be installed between the floor-mounted console and the vehicle seat to trap objects that might fall between or under the vehicle seats. In accordance with the teachings of the present invention, there is disclosed a semi-flexible trapping device for vehicle use, which is formed of a cylindrical member with two side flaps that is designed to apply a horizontal force, and allowing both flaps with the means to hold the device firmly in place when it is installed between the floor-mounted console and the vehicle seat.

The accompanying drawings show illustrative embodiment of the present invention from which the features and advantages will be readily apparent.

### BRIEF DESCRIPTION OF THE DRAWINGS

FIG. 1 is a perspective view of an assembly in accordance with the embodiment of the present invention.

FIG. 2 is an elevation view of the assembly shown in FIG. 1.

FIG. 3 is an exploded perspective view of the assembly shown in FIG. 1.

### DETAILED DESCRIPTION OF THE INVENTION

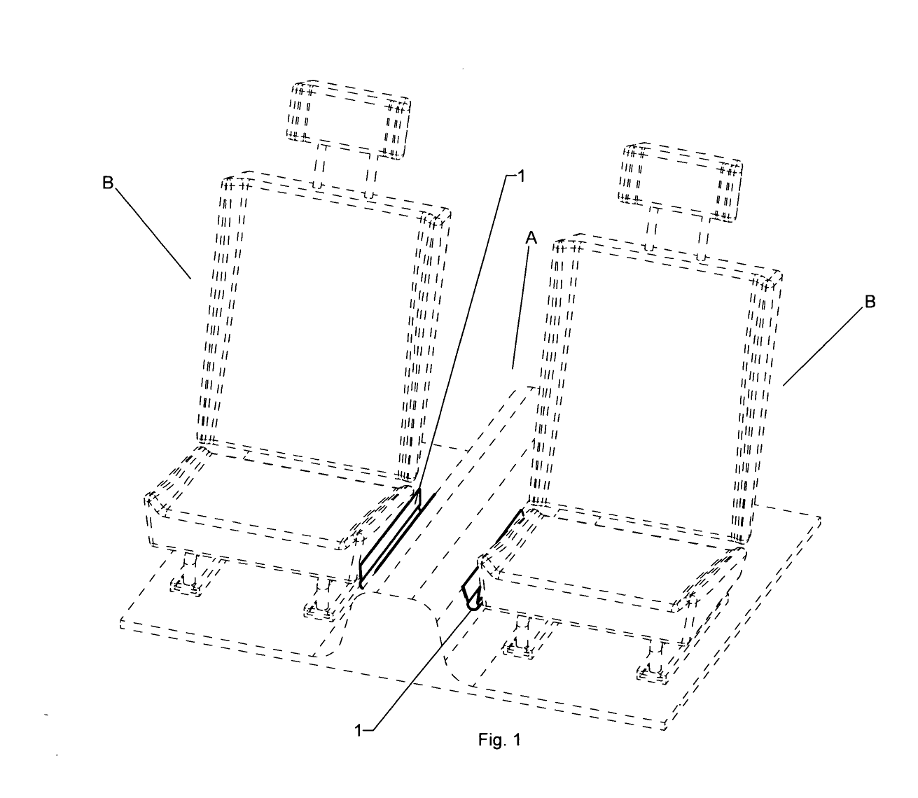

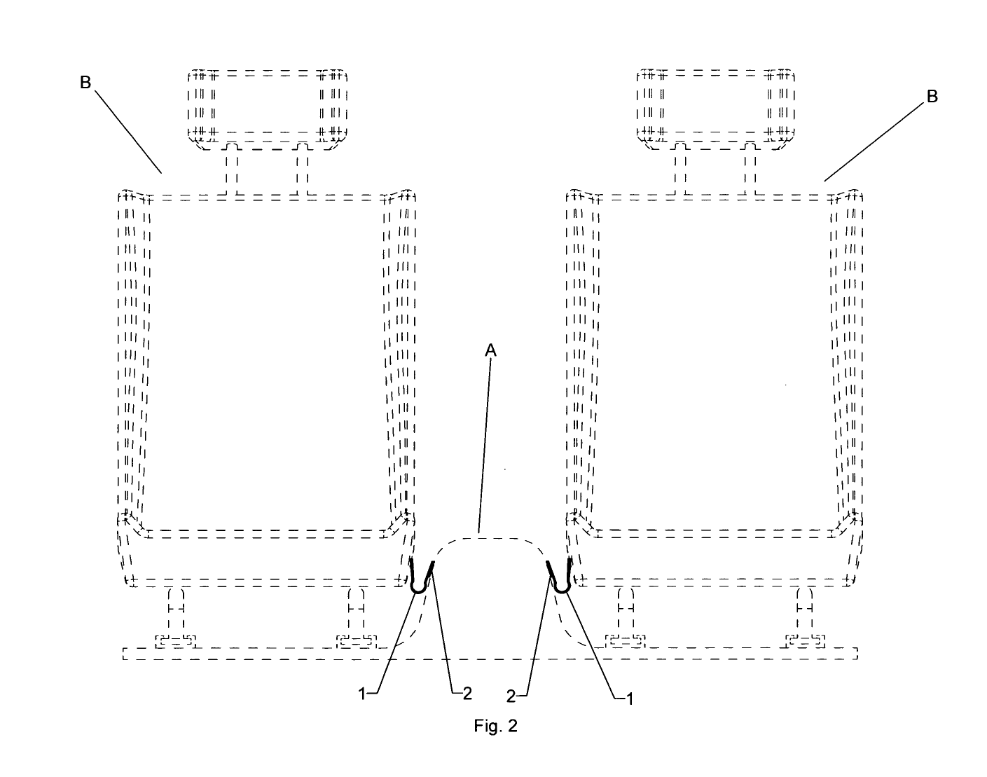

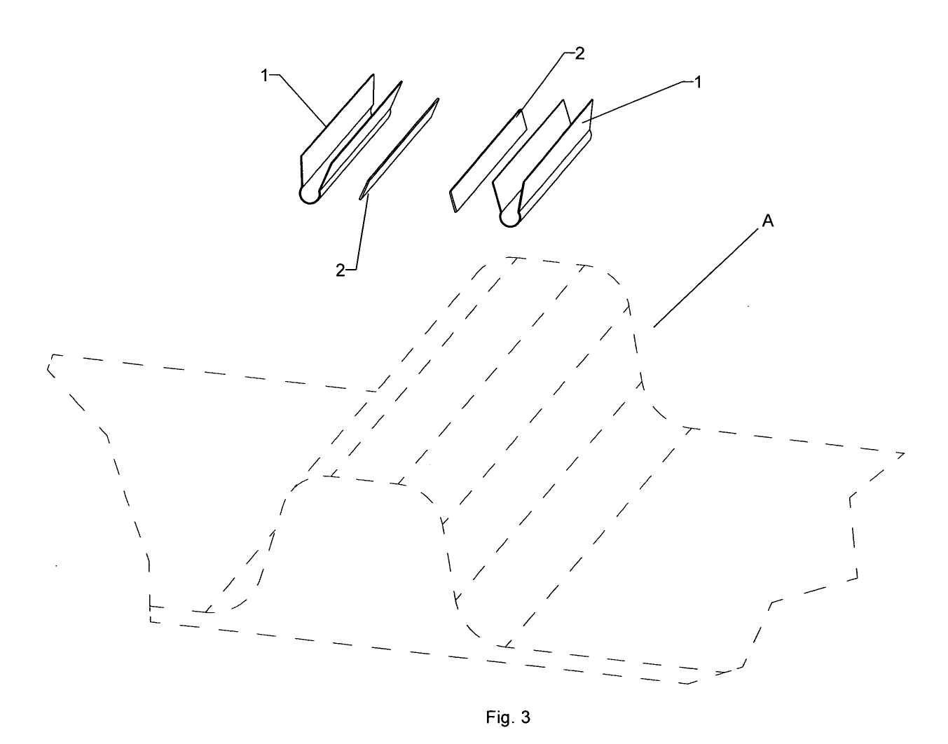

According to the embodiment of the present invention, as depicted in FIGS. 1 to 3, it is shown a semi-flexible trapping device (1) for vehicle use, which is formed of a cylindrical member with two side flaps that is designed to apply a horizontal force, and allowing both flaps with the means (2) to hold the device firmly in place when it is installed between the floor-mounted console (A) and the vehicle seat (B).

Although only a single embodiment of the present invention has been described and illustrated, the present invention is not limited to the features of this embodiment, but includes all variations and modifications within the scope of claims.

The embodiments of the invention for which an exclusive property or privilege is claimed, are defined as follows:

1. A trapping device for vehicle use, which comprising a cylindrical member with two side flaps that is designed to apply a horizontal force, and allowing both flaps with the means to hold the device firmly in place when it is installed between the floor-mounted console and the vehicle seat.
